(19) United States
(12) Patent Application Publication
(10) Pub. No.: US 2022/0083911 A1
(43) Pub. Date: Mar. 17, 2022

(54) Enhanced Privacy Federated Learning System

(71) Applicant: Huawei Technologies Co., Ltd., Shenzhen (CN)

(72) Inventors: Adrian Flanagan, Helsinki (FI); Kuan Eeik Tan, Helsinki (FI); Qiang Fu, Helsinki (FI)

(21) Appl. No.: 17/423,695

(22) PCT Filed: Jan. 18, 2019
(86) PCT No.: PCT/EP2019/051250

§ 371 Date: Jul. 16, 2021

(51) Int. Cl. G06N 20/00

(52) U.S. Cl. CPC G06N 20/00

(57) ABSTRACT

A user equipment includes a processor configured to download a master machine learning model for generating a user recommendation related to use of an application of the user equipment, calculate a model update for the master machine learning model using the master machine learning model and data related to one or more of a user of the user equipment or a user interaction with the user equipment, encode the calculated model update using an ε-differential privacy mechanism and transmit the ε-differential privacy encoded model update.

### TECHNICAL FIELD

The aspects of the present disclosure relate generally to Federated Learning Systems and Federated Recommendation Systems and more particularly to enhancing privacy of data in a Federated Learning or Recommendation System.

### BACKGROUND

Federated Learning and Federated Recommendation systems have been shown to have a high level of inherent user privacy preserving qualities. The reason for this is mainly due to the user data remaining on the user equipment or device while the user recommendations are also generated on the user equipment. The part of a Federated Learning or Recommendation system that is most vulnerable to reducing user privacy is access to the model updates that are moved between the user equipment and the backend server.

While different methods based on secure aggregation techniques have been proposed to solve the problems related to protection of user data in these systems, such methods typically require a sophisticated system of pair-wise (between users) secure communication channels involving security measures such as key sharing, for example. This requires extra infra-structure, resources and management of different processes. These methods may also not be so robust in terms of users dropping out.

Accordingly, it would be desirable to be able to provide a system that addresses at least some of the problems identified above.

### SUMMARY

It is an object of the disclosed embodiments to provide an apparatus and method that enhances privacy of federated learning. This object is solved by the subject matter of the independent claims. Further advantageous modifications can be found in the dependent claims.

According to a first aspect the above and further objects and advantages are obtained by a user equipment. In one embodiment, the user equipment includes a processor configured to configured to download a master machine learning model for generating a user recommendation related to one or more of a use or interaction with an application of the user equipment; calculate a model update for the master machine learning model using the master machine learning model and data related to one or more of a user of the user equipment or a user interaction with the user equipment; encode the calculated model update using an ε-differential privacy mechanism; and transmit the ε-differential privacy encoded model update. The aspects of the disclosed embodiments enhance the privacy of a federated learning system by applying F-Differential Privacy (DP) to the model updates uploaded from the user equipment to the backend server. The privacy of the user is further enhanced as the model updates are hashed and randomized and cannot be decoded individually to learn anything about the user. The aspects of the disclosed embodiments do not require additional infrastructure or communication channels or need to share keys/data between individual users, and no management of encryption keys is required, which reduces the amount of required computational resources.

In a possible implementation form of the user equipment according to the first aspect, the downloaded master machine learning model is one or more of a collaborative filter (CF) model or a Federated Learning collaborative filter model. The aspects of the disclosed embodiments can be applied to a general set of Machine Learning algorithms in Federated Learning mode, and more specific filter models.

In a possible implementation form of the user equipment according to the first aspect as such or the previous possible implementation form, the processor is configured to generate the user recommendation related to the use of the application based on the downloaded master machine learning model and the data related to one or more of the user of the user equipment or the user interaction with the user equipment. The aspects of the disclosed embodiments minimize the risk of exposing user data by generating the recommendations on the user equipment.

In a further possible implementation form of the apparatus, the application is a video service. The aspects of the disclosed embodiments provide a high level of user privacy when the user uses the personalised recommendations that propose video choices to the user based on video preference selections, user demographic and/or gender data, or videos they have previously selected and/or watched through the service.

According to a second aspect, the above and further objects and advantages are obtained by a server apparatus. In one embodiment, the server apparatus includes a processor that is configured to receive a plurality of ε-differential privacy encoded model updates for a master machine learning model; aggregate the plurality of the received ε-differential privacy encoded updates; decode the aggregation of the plurality of received ε-differential privacy encoded updates to recover an aggregated version of the plurality of received ε-differential privacy encoded updates; and update the master machine learning model from the aggregated version of the aggregated version of the plurality of received ε-differential privacy encoded updates. The aspects of the disclosed embodiments use ε-Differential Privacy to encode the model updates sent from a user equipment to the backend in such a way that it is impossible or very difficult for any agent (including the backend itself) to intercept or view the encoded updates to reverse engineer the encoded updates to extract any useful information about the user data. By aggregating the encoded model updates from many users and decoding the resulting aggregate an estimate of the actual model updates can be calculated. This aggregate of the model updates is all that is required in the Federated Learning system as opposed to knowing the updates from the individual users. This further enhances the privacy properties of Federated Learning.

In a possible implementation form of the server apparatus according to the second aspect as such the master machine learning model is one or more of a collaborative filter (CF) model or a Federated Learning collaborative filter model. The aspects of the disclosed embodiments can be applied to a general set of Machine Learning algorithms in Federated Learning mode, and more specific filter models.

In another possible implementation form of the server apparatus according to the second aspect as such, the processor is configured to aggregate the plurality of received ε-differential privacy encoded updates as a sum of the plurality of received ε-differential privacy encoded updates. The aspects of the disclosed embodiments make it difficult for anyone looking at the encoded versions of the model updates to extract accurate information from the encoded model updates. By aggregating the encoded model updates from many users and decoding the resulting aggregate, an estimate of the actual model updates can be calculated. This aggregate of the model updates is all that is required in the Federated Learning system as opposed to knowing the updates from the individual users, which further enhances privacy.

According to a third aspect, the above and further objects and advantages are obtained by a method. In one embodiment, the method includes downloading to a user equipment, a master machine learning model for generating a recommendation related to an application of the user equipment; calculating a model update for the master machine learning model using the master machine learning model and data related to one or more of a user of the user equipment or a user interaction with the user equipment; encoding the model update using an c-differential privacy mechanism; and transmitting the encoded model update from the user equipment to a server. In one embodiment the master machine learning model is downloaded from a backend server associated with an application service. The aspects of the disclosed embodiments enhance the privacy of a federated learning system by applying ε-Differential Privacy (DP) to the model updates uploaded from the user equipment to the backend server. The privacy of the user is further enhanced as the model updates are hashed and randomized and cannot be decoded individually to learn anything about the user. This makes it very difficult, if not impossible for any agent, including the backend itself, to intercept or view the encoded updates to reverse engineer the encoded updates to extract any useful information about the user data. The use of computational resources is reduced compared to other methods using secure communications, encryption and decryption.

In a possible implementation form of the method according to the third aspect as such, the master machine learning model is one or more of a collaborative filter (CF) model or a Federated Learning collaborative filter model. The aspects of the disclosed embodiments can be applied to a general set of Machine Learning algorithms in Federated Learning mode, and more specific filter models.

In a possible implementation form of the method according to the third aspect as such, the method further includes receiving, in the server, a plurality of ε-differential privacy encoded model updates for the master machine learning model; aggregating the plurality of ε-differential privacy encoded model updates; decoding the aggregation of the ε-differential privacy encoded model updates to recover an aggregated version of the received plurality of εprivacy encoded model updates; and updating the master machine learning model from the recovered aggregated version. The aspects of the disclosed embodiments make it difficult for anyone looking at the encoded versions of the model updates to extract accurate information from the encoded model updates. By aggregating the encoded model updates from many users and decoding the resulting aggregate, an estimate of the actual model updates can be calculated. This aggregate of the model updates is all that is required in the Federated Learning system as opposed to knowing the updates from the individual users, which further enhances privacy.

In a further possible implementation form of the method according to the third aspect as such, the method further includes aggregating the plurality of ε-differential privacy encoded model updates as a sum of the plurality of ε-differential privacy encoded model updates. By aggregating the encoded model updates from many users and decoding the resulting aggregate an estimate of the actual model updates can be calculated. This aggregate of the model updates is all that is required in the Federated Learning system as opposed to knowing the updates from the individual users.

In a further possible implementation form of the method according to the third aspect as such, the application is a video service running on the user equipment. The aspects of the disclosed embodiments provide a high level of user privacy when the user uses the personalised recommendations that propose for example video choices to the user based on for example, videos they have previously watched through the service, user demographics, user gender and user preferences selected through the application and service.

According to a fourth aspect, the above and further objects and advantages are obtained by a method. In one embodiment, the method includes receiving in a server, a plurality of ε-differential privacy encoded model updates for a master machine learning model; aggregating the plurality of ε-differential privacy encoded machine learning model updates; decoding the aggregation of the ε-differential privacy encoded plurality of master machine learning model updates to recover an aggregated version of the received plurality of ε-differential privacy encoded master machine learning model updates; and updating the master machine learning model from the recovered aggregated version. The aspects of the disclosed embodiments use ε-Differential Privacy to encode the model updates sent from a user's device to the backend in such a way that it is impossible or very difficult for any agent (including the backend itself) to intercept or view the encoded updates to reverse engineer the encoded updates to extract any useful information about the user data. By aggregating the encoded model updates from many users and decoding the resulting aggregate an estimate of the actual model updates can be calculated. This aggregate of the model updates is all that is required in the Federated Learning system as opposed to knowing the updates from the individual users. This further enhances the privacy properties of Federated Learning.

In a possible implementation form of the method according to the fourth aspect as such, the method further includes aggregating the plurality of ε-differential privacy encoded machine learning model updates as a sum of the plurality of ε-differential privacy encoded machine learning model updates. By aggregating the encoded model updates from many users and decoding the resulting aggregate an estimate of the actual model updates can be calculated. This aggregate of the model updates is all that is required in the Federated Learning system as opposed to knowing the updates from the individual users

According to a fifth aspect, the above and further objects and advantages are obtained by a non-transitory computer readable media having stored thereon program instructions that when executed by a processor cause the processor to perform the method of the possible implementations forms recited herein.

According to a sixth aspect, the processor is configured to execute non-transitory machine readable program instructions to perform the method of the possible implementation forms recited herein.

These and other aspects, implementation forms, and advantages of the exemplary embodiments will become apparent from the embodiments described herein considered in conjunction with the accompanying drawings. It is to be understood, however, that the description and drawings are designed solely for purposes of illustration and not as a definition of the limits of the disclosed invention, for which reference should be made to the appended claims. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### BRIEF DESCRIPTION OF THE DRAWINGS

In the following detailed portion of the present disclosure, the invention will be explained in more detail with reference to the example embodiments shown in the drawings, in which:

FIG. 1 illustrates a schematic view of exemplary system incorporating aspects of the disclosed embodiments.

FIG. 2 illustrates a schematic view an exemplary Federated Learning system incorporating aspects of the disclosed embodiments

FIG. 3 illustrates an exemplary method incorporating aspects of the disclosed embodiments.

FIG. 4 illustrates an exemplary method incorporating aspects of the disclosed embodiments.

FIG. 5 illustrates a schematic of an exemplary apparatus that can be used to practice aspects of the disclosed embodiments.

### DETAILED DESCRIPTION OF THE DISCLOSED EMBODIMENTS

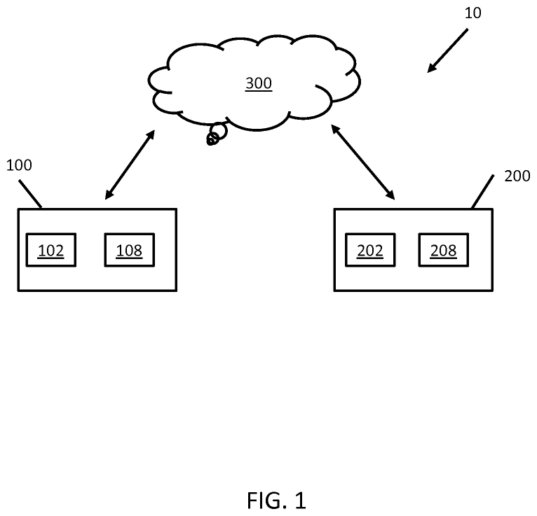

Referring to FIG. 1 there can be seen a front view of an exemplary system 10 incorporating aspects of the disclosed embodiments. The aspects of the disclosed embodiments are directed to a system 100 that enhances the privacy level of a Federated Learning system by applying ε-Differential Privacy (DP) to the model updates uploaded from the user device 100 to the backend server 200. In one embodiment, the model update is encoded on the user device or equipment 100 and an aggregation of the user model updates is decoded on the backend server or device 200.

In one embodiment, referring to FIG. 1, the user equipment or device 100, generally referred to herein as user equipment 100, includes one or more processors 102 connected or coupled to one or more memory devices 108. The user equipment 100 can include any suitable communication or computing device, such as a mobile computing or communication device. The system 10 also includes a server 200, also referred to as backend server 200. The backend server 200 can include one or more processors 202 connected or coupled to one or memory device(s) 208. In one embodiment, the processor 102 is configured to execute non-transitory machine readable program instructions.

The processor 102 is configured to download a master machine learning model for generating a user recommendation related to use of an application of the user equipment 100. In one embodiment, the master machine learning model can be downloaded from the backend server 200 to the user equipment 100. The user recommendation can provide one or more different options, or recommendations, to the user related to the use of the application or service. The processor 102 can then calculate a model update for the master machine learning model based on the master machine learning model and data related to one or more of the user of the user equipment or the user's interaction with the user equipment.

In one embodiment, the data, also referred to as user data, can have different types. For example, the data can include data obtained or recorded from the user's interaction with the application or service. This can include data recorded based on a user's selection of an item or option of the application, or selection of one or more items being recommended. For example, when the application is a video service, the data can include information pertaining to a video watched by the user in the video service.

Another form of data can include information about the user. For example, the data can include any form of user demographic data. The data can include meta data such as location of the user and the user equipment, a type of the user equipment, user gender, or user age, or any combination thereof. In alternate embodiment, the data can include user behavioural data and/or user meta data, or any combination thereof. In one embodiment, this data is obtained by and stored locally in the user equipment 100. In alternate embodiments, this type of data is obtained in any suitable manner and stored on any suitable storage medium accessible by the user equipment 100.

The calculated model update is encoded using an c-differential privacy mechanism, and the c-differential privacy encoded model update is then transmitted. In one embodiment, the encoded model update is transmitted to the apparatus 200, referred to herein as the server, or backend server. As is illustrated in FIG. 1, in one embodiment, the user equipment 100 and apparatus 200 are communicatively coupled together via a communication network 300, such as for example the Internet or the cloud.

The aspects of the disclosed embodiments use ε-Differential Privacy (DP) to encode a model update on the user equipment or device 100 and decode an aggregation of user model updates on the backend server 200. DP allows, for example numbers, to be encoded by a process involving hashing and randomization. This hashing-randomization process is applied to the model updates (which are numbers) and instead of transferring the plain model updates from the user device 100 to the backend server 200, the encoded version is transferred from the user device 100 to the backend server 200.

Anyone looking at the encoded versions of the model updates would find it very difficult, even impossible to extract accurate information from the encoded model updates. However on the server side 200, by aggregating the encoded model updates from many user devices 100, and decoding the resulting aggregate, an estimate of the actual model updates can be calculated. This aggregate of the model updates is all that is required in the Federated Learning system 10, as opposed to knowing the updates from the individual user devices 100.

Advantages of the method of the disclosed embodiments is that the privacy of the user of the user device 100 is further enhanced as the model updates are hashed and randomized and cannot be decoded individually to learn anything about the user. However Federated Learning can still be used as only the aggregate of the updates is required and this can be extracted from the aggregate of the individual encoded user model updates.

Compared to other approaches, the method of the disclosed embodiments requires no additional infrastructure or communication channels, or the need to share keys/data between individual user devices 100. Management of encryption keys is not required. The hashing-randomisation process on the user device 100 is straightforward and not resource consuming. The use of computational resources and processing is reduced compared to other methods using secure communications, encryption and decryption of updates. Thus, the aspects of the disclosed embodiments afford a comparable level of privacy as other methods, but in a much simpler and more resource efficient manner.

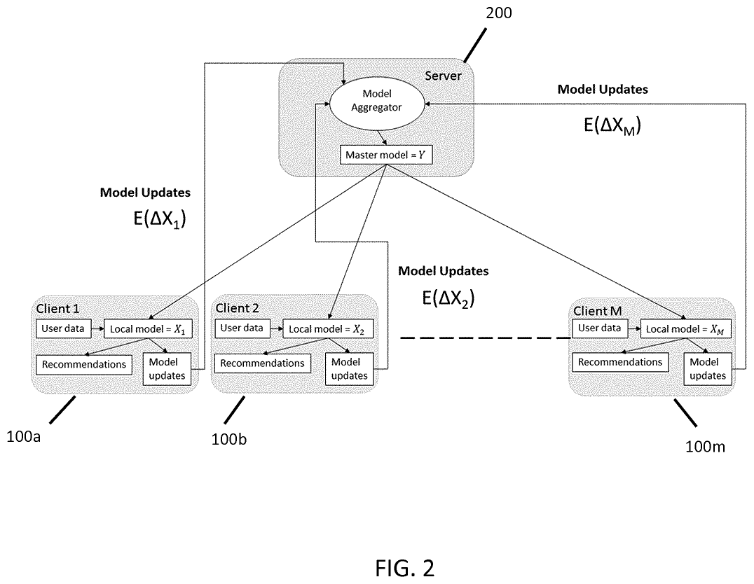

Referring to FIG. 2, one example of a Federated Learning System incorporating aspects of the disclosed embodiments is illustrated. In this example, the system includes one or more user equipment or device 100a-100m, also referred to as client devices. The devices 100a-100m are communicatively coupled to the backend server 200. In this example, model updates ΔXi are generated from the model Xᵢ and user data. Under a given set of conditions it may be possible for a curious or malicious agent to manipulate the ΔXᵢ to extract some information on the original user data used to generate the updates. However, in accordance with the aspects of the disclosed embodiments, to mitigate this risk, Differential Privacy encoding is applied to the model updates ΔXi as described below.

As shown in FIG. 2, in one embodiment, the Master model Y in the Federated Learning (FL) mode is distributed to all of the user devices 100a-100m from the backend server 200. The collaborative filter (CF) in this example is a Federated Collaborative Filter (FCF). Although the aspects of the disclosed embodiments will generally be described herein with respect to a collaborative filter, such as the Federated Collaborative Filter, the aspects of the disclosed embodiments are not so limited. In alternate embodiments, the aspects of the disclosed embodiments can be applied to a more general set of machine learning algorithms in a Federated Learning mode. This can include any master machine learning model for generating a recommendation.

The Master model Y for the Federated Collaborative Filter (FCF) can be a matrix of numbers, such as for example [[0.2, 0.4, 0.6], [0.1, 0.3, 0.5], [0.7, 0.8, 0.9] . . . ]. The Master model Y will be stored locally on the user equipment 100a-100m as Xᵢ. The storage can utilize a memory 108, such as that shown in FIG. 1.

Using a combination of the locally stored master model Xᵢ and local user data, such as for example videos the user has previously watched, a set of personalised recommendations for the user of the user equipment 100a-100m can be generated. The model updates ΔXᵢ to “learn” the model Y are then calculated in the user equipment 100a-100m for each user or client, such as Client 1-Client M, respectively, from the master model Xᵢ stored locally on a specific user equipment 100a-100m, and the corresponding local user data.

The model updates ΔXᵢ is also a matrix of numbers, such as for example [[0.04, −0.01, −0.02], [0.08, −0.05, 0.03], [−0.04, 0.01, −0.03] . . . ]. Differential Privacy encoding is applied to the model update ΔXᵢ of a particular user equipment 100a-100m to give E(ΔXᵢ)=[[*, *, *], [*, *, *], [*, *, *] . . . ] the DP encoded updates.

The encoded model updates E(ΔXᵢ) are transferred back to the back end server 200 and are aggregated on the server 200 as

E(ΔY)=ΣᵢΔXᵢ

A decoding is applied to E(ΔY) to give an approximation to ΔY:

[symbol]

=E⁻¹(E(ΔY))≈ΔY

The master model Y is updated as:

Y=Y+η

[symbol]

The process can continue with the distribution of the updated master model Y, as described above. Thus, the example of FIG. 2 shows the application of Differential Privacy encoding applied to the model updates ΔXᵢ sent from the client or user equipment 100 back to the server 200 and the training of a machine learning model in federated mode with the application of differential privacy to the model updates ΔXᵢ as applied to the FCF,

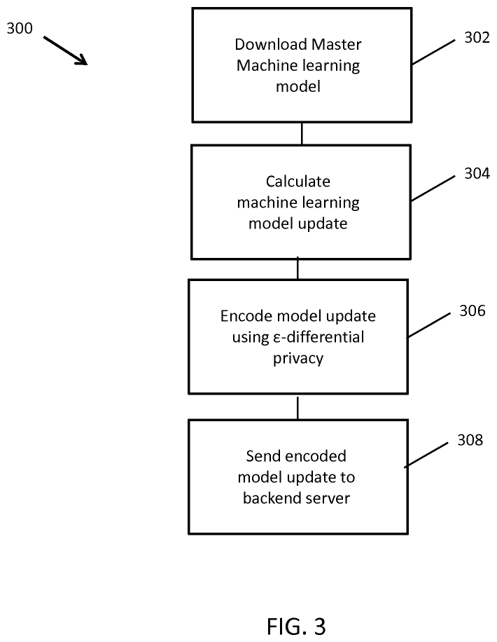

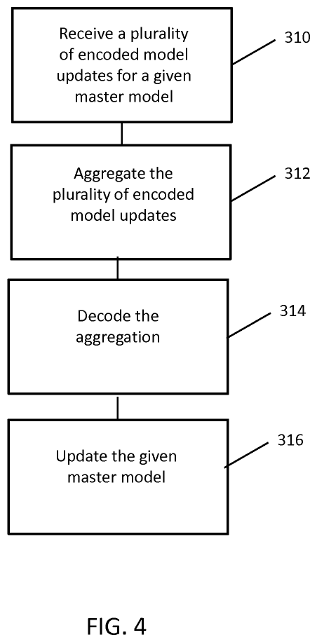

FIGS. 3 and 4 illustrate an exemplary process flow incorporating aspects of the disclosed embodiments. As is illustrated in FIG. 3, a master machine learning model is downloaded 302 to a particular user device, such as user equipment 100 shown in FIG. 1. The master machine learning model can be downloaded from the server 200, for example. As described above with respect to FIG. 2, this can be the master model Y. The machine learning model update is calculated 304, such as for example the model update ΔXᵢ described above with reference to FIG. 2.

The model update ΔXᵢ is encoded 306 by applying ε-Differential Privacy. The encoded model update, referred to as E(ΔXᵢ) is then sent 308 to the backend server, such as the backend server 200 of FIGS. 1 and 2.

Referring to FIG. 4, in one embodiment, a plurality of encoded model updates E(ΔXᵢ) are received 310 at the backend server, such as backend server 200 illustrated in FIGS. 1 and 2. The plurality of encoded model updates E(ΔXᵢ) will be for a given master model Y. The plurality of encoded model updates E(ΔXᵢ) will be aggregated 312 and decoded 314, generally as described with respect to FIG. 2. The given master model Y will be updated 316.

As an example, Huawei video service provides an application to users to run on their mobile device that allows them to watch videos through the service. The service backend is hosted in a cloud service. The video service would like to offer users a personalised recommendation service to propose video choices to users based on videos they have previously watched through the service, as well as other user specific preferences and demographics. The video service would like to provide the highest level of user privacy they can when the user uses the personalised recommendations. The video service decides to use a Collaborative Filter (CF) recommendation algorithm/model and use a Federated Learning mode to build and update the CF model. In particular they decide to use a Federated version of CF or FCF.

In accordance with the aspects of the disclosed embodiments, the video service applies ε-Differential Privacy to encode the model updates. The encoded model updates are then sent, via the cloud service, to the service backend. The service backend aggregates the encoded model updates and decodes the resulting aggregate to calculate an estimate of the actual model updates. In this manner, the privacy of the user is enhanced since the model updates cannot be decoded individually to learn anything about the user.

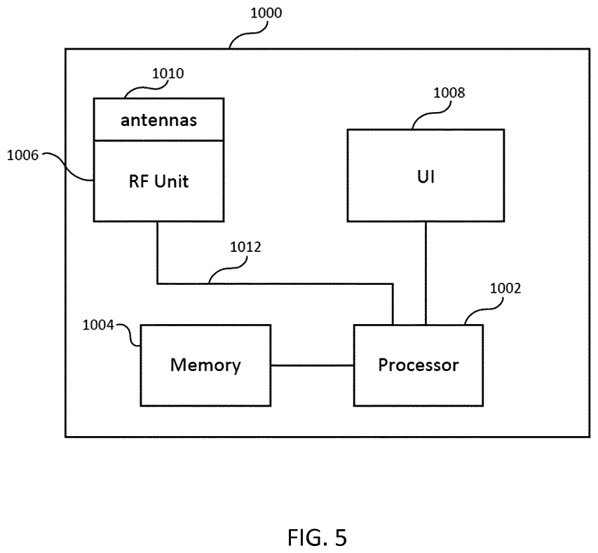

FIG. 5 illustrates a block diagram of an exemplary apparatus 1000 appropriate for implementing aspects of the disclosed embodiments. The apparatus 1000 is appropriate for use in a wireless network and can be implemented in one or more of the user equipment apparatus 100 or the backend server apparatus 200.

The apparatus 1000 includes or is coupled to a processor or computing hardware 1002, a memory 1004, a radio frequency (RF) unit 1006 and a user interface (UI) 1008. In certain embodiments such as for an access node or base station, the UI 1008 may be removed from the apparatus 1000. When the UI 1008 is removed the apparatus 1000 may be administered remotely or locally through a wireless or wired network connection (not shown).

The processor 1002 may be a single processing device or may comprise a plurality of processing devices including special purpose devices, such as for example, digital signal processing (DSP) devices, microprocessors, graphics processing units (GPU), specialized processing devices, or general purpose computer processing unit (CPU). The processor 1002 often includes a CPU working in tandem with a DSP to handle signal processing tasks. The processor 1002, which can be implemented as one or more of the processors 102 and 202 described with respect to FIG. 1, may be configured to implement any one or more of the methods and processes described herein.

In the example of FIG. 5, the processor 1002 is configured to be coupled to a memory 1004 which may be a combination of various types of volatile and non-volatile computer memory such as for example read only memory (ROM), random access memory (RAM), magnetic or optical disk, or other types of computer memory. The memory 1004 is configured to store computer program instructions that may be accessed and executed by the processor 1002 to cause the processor 1002 to perform a variety of desirable computer implemented processes or methods such as the methods as described herein. The memory 1004 may be implemented as one or more of the memory devices 108, 208 described with respect to FIG. 1.

The program instructions stored in memory 1004 are organized as sets or groups of program instructions referred to in the industry with various terms such as programs, software components, software modules, units, etc. Each module may include a set of functionality designed to support a certain purpose. For example a software module may be of a recognized type such as a hypervisor, a virtual execution environment, an operating system, an application, a device driver, or other conventionally recognized type of software component. Also included in the memory 1004 are program data and data files which may be stored and processed by the processor 1002 while executing a set of computer program instructions.

The apparatus 1000 can also include or be coupled to an RF Unit 1006 such as a transceiver, coupled to the processor 1002 that is configured to transmit and receive RF signals based on digital data 1012 exchanged with the processor 1002 and may be configured to transmit and receive radio signals with other nodes in a wireless network. In certain embodiments, the RF Unit 1006 includes receivers capable of receiving and interpreting messages sent from satellites in the global positioning system (GPS) and work together with information received from other transmitters to obtain positioning information pertaining to the location of the computing device 1000. To facilitate transmitting and receiving RF signals the RF unit 1006 includes an antenna unit 1010 which in certain embodiments may include a plurality of antenna elements. The multiple antennas 1010 may be configured to support transmitting and receiving MIMO signals as may be used for beamforming.

The UI 1008 may include one or more user interface elements such as a touch screen, keypad, buttons, voice command processor, as well as other elements adapted for exchanging information with a user. The UI 1008 may also include a display unit configured to display a variety of information appropriate for a computing device or mobile user equipment and may be implemented using any appropriate display type such as for example organic light emitting diodes (OLED), liquid crystal display (LCD), as well as less complex elements such as LEDs or indicator lamps.

The aspects of the disclosed embodiments are directed to the use of F-Differential Privacy to encode the model updates sent from a user's device to the backend. In this manner, it is impossible or very difficult for any agent intercepting or viewing the encoded updates to reverse engineer the encoded updates to extract any useful information about the user data. This further enhances the privacy properties of Federated Learning.

Thus, while there have been shown, described and pointed out, fundamental novel features of the invention as applied to the exemplary embodiments thereof, it will be understood that various omissions, substitutions and changes in the form and details of devices and methods illustrated, and in their operation, may be made by those skilled in the art without departing from the spirit and scope of the presently disclosed invention. Further, it is expressly intended that all combinations of those elements, which perform substantially the same function in substantially the same way to achieve the same results, are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-15. (canceled)

16. A user equipment comprising:
memory; and
a processor coupled to the memory and configured to cause the user equipment to:
download a master machine learning model for generating a user recommendation related to use of an application of the user equipment;
calculate a model update for the master machine learning model using the master machine learning model and data related to one or more of a user of the user equipment or a user interaction with the user equipment;
encode the model update using an ε-differential privacy mechanism to obtain an ε-differential privacy encoded model update; and
transmit the ε-differential privacy encoded model update.

17. The user equipment of claim 16, wherein the master machine learning model is a collaborative filter (CF) model.

18. The user equipment of claim 16, wherein the master machine learning model is a federated learning collaborative filter model.

19. The user equipment of claim 16, wherein the data is related to the user.

20. The user equipment of claim 16, wherein the data is related to the user interaction with the user equipment.

21. The user equipment of claim 16, wherein the processor is further configured to cause the user equipment to generate the user recommendation based on the master machine learning model and the data.

22. The user equipment of claim 21, wherein the application is a video service.

23. The user equipment of claim 16, wherein the ε-differential privacy encoded model update is transmitted to a server.

24. A server comprising:
memory; and
a processor coupled to the memory and configured to cause the server to:
receive a plurality of ε-differential privacy encoded model updates for a master machine learning model;
aggregate the plurality of ε-differential privacy encoded updates to obtain an aggregation;
decode the aggregation to recover a decoded aggregated version of the plurality of ε-differential privacy encoded updates; and
update the master machine learning model from the decoded aggregated version.

25. The server of claim 24, wherein the master machine learning model is a collaborative filter (CF) model.

26. The server of claim 24, wherein the master machine learning model is a federated learning collaborative filter model.

27. The server of claim 25, wherein the processor is further configured to cause the server to aggregate the plurality of ε-differential privacy encoded updates as a sum of the plurality of ε-differential privacy encoded updates.

28. A method comprising:
downloading, by a user equipment, a master machine learning model for generating a user recommendation related to use of an application of the user equipment;
calculating, by the user equipment, a model update for the master machine learning model using the master machine learning model and data related to one or more of a user of the user equipment or a user interaction with the user equipment;
encoding, by the user equipment, the model update using an ε-differential privacy mechanism to obtain an ε-differential privacy encoded model update; and
transmitting, by the user equipment, the ε-differential privacy encoded model update to a server.

29. The method of claim 28, wherein the master machine learning model is a collaborative filter (CF) model.

30. The method of claim 28, wherein the master machine learning model is a federated learning collaborative filter model.

31. The method of claim 28, further comprising:
receiving, in the server, a plurality of ε-differential privacy encoded model updates for the master machine learning model;
aggregating the plurality of ε-differential privacy encoded model updates to obtain an aggregation;
decoding the aggregation to recover a decoded aggregated version of the plurality of ε-differential privacy encoded model updates; and
updating the master machine learning model from the decoded aggregated version.

32. The method of claim 28, further comprising aggregating the plurality of ε-differential privacy encoded model updates as a sum of the plurality of ε-differential privacy encoded model updates.

33. The method of claim 28, wherein the application is a video service running on the user equipment.

34. The method of claim 28, wherein the data is related to the user.

35. The method of claim 28, wherein the data is related to the user interaction with the user equipment.
